(19) United States
(12) Patent Application Publication
(10) Pub. No.: US 2014/0149097 A1
(43) Pub. Date: May 29, 2014

(54) METHOD TO DETERMINE LOTION EFFECTIVENESS OF A VIRTUAL ABSORBENT ARTICLE

(71) Applicant: THE PROCTER & GAMBLE COMPANY, Cincinnati, OH (US)

(72) Inventors: Mel Allende-Blanco, Loveland, OH (US); Thomas Alva Baer, Liberty Township, OH (US); Brent Taylor Ginn, Massillon, OH (US)

(73) Assignee: THE PROCTER & GAMBLE COMPANY, Cincinnati, OH (US)

(21) Appl. No.: 13/688,523

(22) Filed: Nov. 29, 2012

(51) Int. Cl. G06F 17/50

(52) U.S. Cl. CPC G06F 17/5009
USPC 703/9

(57) ABSTRACT

Methods of using computer based models for interaction between a lotion and a surface.

### FIELD

In general, the present disclosure relates to computer based models for absorbent articles. In particular, the present disclosure relates to methods of using computer based models to determine the effectiveness of lotion treated surfaces in the absorption of bodily exudates.

### BACKGROUND

Designers of absorbent articles have traditionally relied upon results from physical testing of prototypes to evaluate the performance of absorbent articles and as a basis for making design changes. Developing prototypes of absorbent articles can be expensive because the equipment necessary to manufacture the absorbent article may not be developed at the time when new absorbent articles are being designed. In some instances, the materials from which the absorbent article will be constructed have yet to be developed. Furthermore, physical testing often requires working in a controlled laboratory environment, which can be expensive. In the case of hygienic products, such as catamenial devices, wound dressings, facial tissue, diapers, and diaper wipes, laboratory personnel may be exposed to increased risks to their health as a result of handling animal exudates during laboratory tests. For absorbent articles designed to absorb other materials, physical testing may require that laboratory personnel be exposed to unhealthy chemicals that the absorbent article is designed to absorb.

Obtaining data describing the transient behavior of absorbent articles can be challenging. Often, a designer of absorbent articles is interested in how the absorbent article being designed acquires exudate at the onset of exposure to an exudate. A designer may additionally desire to add a lotion to the absorbent article. The use of lotions is used to both treat the skin and to promote fluid absorption of the bodily fluid. However, different lotion properties may affect the way that an absorbent article interacts with the bodily exudates. By the time the designer removes the absorbent article from exposure to the exudate, dissects the absorbent article, places portions of the absorbent article in a device capable of measuring distribution of exudate, and measures the distribution of the exudate, the distribution of the exudate can change significantly as compared to the distribution of exudate when the absorbent article was removed from contact with the exudate.

As a result, it would be beneficial to simulate the interface between an absorbent article and a body as a function of time while incorporating the properties of a potential lotion and an absorbent article to determine the effectiveness of the lotion.

### SUMMARY

A method of simulation that includes providing a virtual body model and a virtual absorbent article model. The method further includes providing parameters to the virtual body model and the virtual absorbent article model. The method further includes running a virtual simulation of the virtual absorbent article model in a proximity with the virtual body model. The method further includes determining the lotion effectiveness of the virtual absorbent article model in proximity with the virtual body model.

### BRIEF DESCRIPTION OF THE DRAWINGS

FIG. 1 is a chart illustrating a method for determining the effectiveness of a virtual absorbent article and virtual body.

FIG. 2 is a chart illustrating a computer system.

FIG. 3 is a graphical representation of an output generated according to the model.

FIG. 4 is a schematic representation of a meshed virtual absorbent article model comprising more than one type of material.

FIG. 5 is a perspective view illustrating a computer based model representing a portion of a female human body.

FIG. 6 is a chart illustrating a method of using computer based models for simulating the discharge and flow of a bodily fluid in an absorbent article.

FIG. 7 is a front view of a virtual absorbent article model worn on a virtual body model.

### DETAILED DESCRIPTION

As used herein, “absorbent article” refers to a device or implement that has the capacity to uptake and/or release a fluid. Non-limiting examples of absorbent articles include absorbent articles worn next to the human body, in particular sanitary napkins, panti-liners, interlabial pads, diapers, pull-on diapers, training pants, incontinence products, wound dressings, and the like. Other non-limiting examples of absorbent articles include paper towels, facial tissue, diaper wipes, floor wipes, countertop wipes, body wipes, toddler wash wipes, bath tissues, toilet paper, handkerchiefs, feminine wipes, breast pads, household wipes, foam, and chamois.

As used herein, “boundary conditions” are defined variables that represent physical factors acting within a computer based model. Examples of boundary conditions include forces, pressures, velocities, and other physical factors. Each boundary condition can be assigned a particular magnitude, direction, and location within the model. These values can be determined by observing, measuring, analyzing, and/or estimating real world physical factors. Computer based models can also include one or more boundary conditions that differ from real world physical factors, in order to account for inherent limitations in the models and/or to more accurately represent the overall physical behaviors of real world things, as will be understood by one of ordinary skill in the art. Boundary conditions can act on the model in various ways, to move, constrain, and/or deform one or more parts in the model.

As used herein, “fluid” refers to a substance that may be absorbed into an absorbent article. Non-limiting examples of a fluid include water, artificial menstrual fluid, menstrual fluid, vaginal discharge, synthetic vaginal discharge, urine, synthetic urine, bowel movement fluids, bowel movement analogs, sweat, synthetic sweat, hexadecane, silicone oil, aqueous carbopol, and mineral oil. Additional non-limiting examples of a fluid also include a substance used for skin care, a lubricant, a surfactant, a cleanser, a detergent or other substance for which an absorbent article can be used to release or dispense a substance. Non-limiting examples of a fluid also include substances commonly spilled such as beverages, petroleum-based products, solvents, and vomit.

As used herein, the term “free bodily fluid” refers to a bodily fluid that is not absorbed within an absorbent article at a set point in time but and is free to move on the absorbent article. Free bodily fluid can be absorbed into an absorbent material over time.

As used herein, “heterogeneous” refers to a material comprised of more than one constituent or ingredient.

As used here in, “initial conditions” are defined variables that present initial factors acting within a computer based model. Examples of initial conditions include initial absorbent article saturation state (i.e. dry or partially saturated).

The present disclosure includes methods of simulating the physical behavior of fluid with a porous media. Embodiments of the present disclosure can at least assist in predicting whether or not a particular absorbent article design can adequately remove, contain, and absorb bodily fluids. As a result, particular absorbent article designs and absorbent materials can be evaluated and modified as computer based models before they are tested as real world things.

Computer aided engineering (CAE) is a broad area of applied science in which technologists use software to develop computer based models that represent real world things. The models can be transformed to provide various information about the physical behavior of those real world things, under certain conditions and/or over particular periods of time. With CAE, the interactions of the computer based models are referred to as simulations. Sometimes the real world things are referred to as a problem and the computer based model is referred to as a solution. There are several major categories of CAE including computational fluid dynamics (CFD).

In CFD, models representing fluids (e.g. liquids and/or gases) are transformed to predict pressure, flow rate, velocity, temperature, and other fluid and/or thermal properties. CFD also represents a continuous fluid material as a set of discrete elements. A CFD element is often referred to as a cell, a finite difference cell, or a finite volume. However, for ease of reference, the term element is used throughout the present disclosure for CFD models. Unless otherwise stated, a reference to an element, in context of CFD, can refer to a cell, a finite difference cell, or a finite volume, as will be understood by one of ordinary skill in the art. In CFD, the fluid behavior is calculated for the elements, using equations that describe fluid behavior. For example, CFD often employs the Navier-Stokes equations, or variations thereof. The equations are solved iteratively, to represent the fluid behavior of the material as a whole.

Commercially available software can be used to conduct CAE. Fluent, from ANSYS, Inc. in Canonsburg, Pa., Flow3D, from Flow Science, Inc. in Santa Fe, N. Mex., and FeFlow from DHI-WASY in Berlin, Germany are examples of commercially available CFD software. Alternatively, CAE software can be written as custom software or may be open source code software, for example, OpenFOAM. CAE software can be run on various computer hardware, such as a personal computer, a minicomputer, a cluster of computers, a mainframe, a supercomputer, or any other kind of machine on which program instructions can execute to perform CAE functions.

CAE models can represent a number of real world things, such as absorbent articles. An absorbent article can receive, contain, and absorb bodily exudates (e.g. urine, menses, feces, etc.). Absorbent articles include products for sanitary protection, for hygienic use, and the like. Fluids modeled may be Newtonian or non-Newtonian.

Representative absorbents may be wearable, non-wearable, reuseable, and/or disposable. Representative absorbents can be an absorbent article. An absorbent article can be a catamenial device comprising a topsheet, a backsheet, and an absorbent core disposed between the topsheet and backsheet. The absorbent article can be a diaper. The absorbent article can dispense a substance. The absorbent article can be selected from the group consisting of pull-on diapers, training pants, incontinence products, feminine wipes, diaper wipes, floor wipes, countertop wipes, body wipes, toddler wash wipes, bath tissues, breast pads, paper towels, toilet paper, facial tissue, wound dressings, handkerchiefs, household wipes, foam, and chamois. Some absorbent articles are wearable. A wearable absorbent article is configured to be worn on or around a lower torso of a body of a wearer. Examples of wearable absorbent articles include diapers and incontinence undergarments.

Some absorbent articles are disposable. A disposable absorbent article is configured to be disposed of after a single use (e.g., not intended to be reused, restored, or laundered). Examples of disposable absorbent articles include disposable diapers, disposable incontinence undergarments, as well as feminine care pads and liners.

Some absorbent articles are reusable. A reusable absorbent article is configured to be partly or wholly used more than once. A reusable absorbent article is configured such that part or all of the absorbent article is durable, or wear-resistant to laundering, or fully launderable. An example of a reusable absorbent article is a diaper with a washable outer cover.

The absorbent can be selected from the group consisting of nonwovens, wovens, apertured polymer films, cellulosic materials, thermoplastic materials, air laid materials, sponges, absorbent gelling materials, foams, rayon, cotton, airfelt, creped cellulose wadding, meltblown polymers, and peat moss.

CAE can be used to design, simulate, and/or evaluate all kinds of absorbent articles, their features, materials, structures, and compositions, as well as their performance characteristics, such as swelling and deformation.

CAE software can also be applied to lotions. CAE can also be used to design, simulate, and/or evaluate lotion features and products. As examples, CAE can be used to simulate the performance of various aspects of lotion products, such interaction with an absorbent article, skin and interaction with bodily exudates.

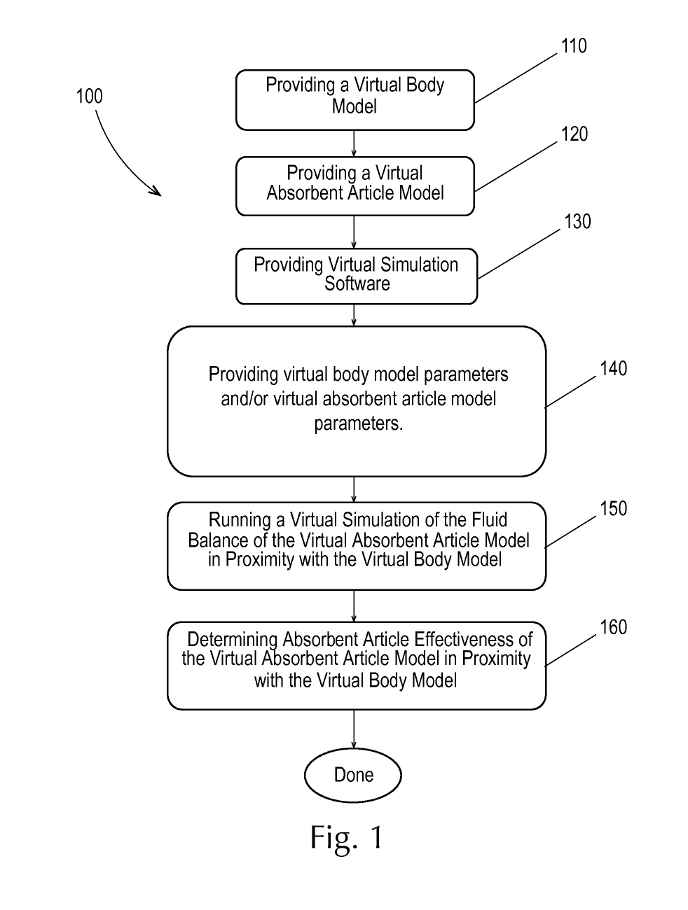

FIG. 1 is a chart illustrating a method 100 of steps 110-160 for using computer based models to determine the effectiveness of lotion clean body benefits. Although the steps 110-160 are described in numerical order in the present disclosure, in various embodiments some or all of these steps can be performed in other orders, and/or at overlapping times, and/or at the same time, as will be understood by one of ordinary skill in the art.

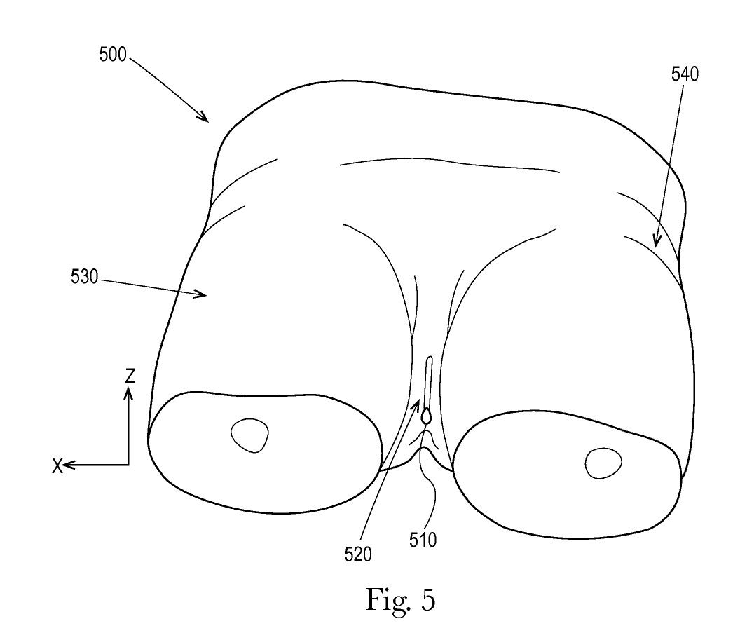

The method 100 includes a first step 110 of providing a virtual body model. The virtual body model can represent a human body with a computer based model. The model can represent an entire human body or can represent one or more portions of a human body. The model can represent a female human body, or an androgynous human body (lacking gender specific anatomical features). The model of the human body can be created as described in connection with the embodiment of FIG. 5.

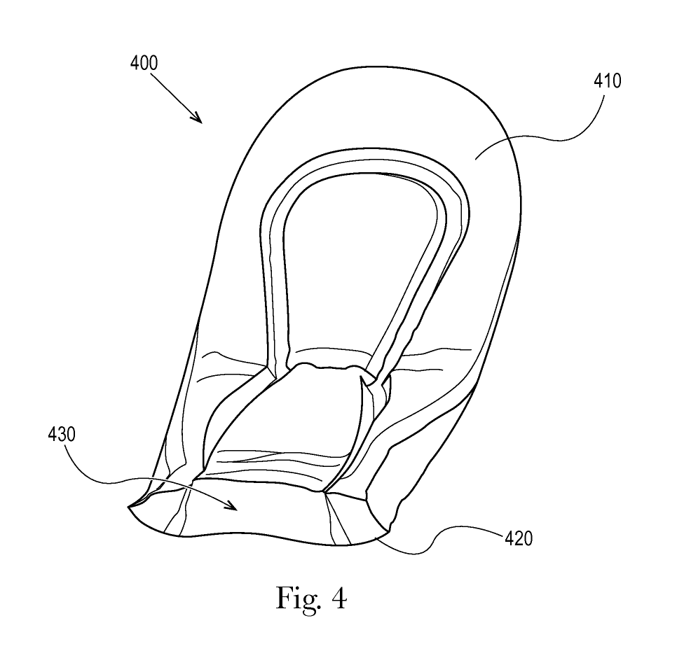

The method includes a second step 120 of providing a virtual absorbent article model. The model of the absorbent article can be created as described in connection with the embodiment of FIG. 4. In the second step 120, the model may represent the absorbent in a dry state, wherein the absorbent article has not been soiled. Alternatively, in the second step 120, the model may represent the absorbent article in a wet state, wherein the article has been partially soiled. The virtual absorbent article model can have a lotion. The lotion can be hydrophobic or hydrophilic. The lotion can be in any layer of the virtual absorbent article including the topsheet, backsheet, or any layer of the absorbent core.

Both the virtual body and virtual absorbent article exhibit certain parameters. Parameters can include permeability, wettability, and material capillarity.

Permeability relates to the state or quality of a material or membrane that causes it to allow liquids or gases to pass through it.

Material capillarity relates to the tendency of a liquid in a capillary tube or absorbent material to rise or fall as a result of liquid surface tension and capillary tube radius or absorbent material pore size distribution.

Wettability relates to the contact angle of the fluid. Similarly, contact angle provides one way to measure the wettability or hydrophobicity of the various samples. A contact angle is the angle, conventionally measured through the liquid, at which a liquid/vapor interface meets a solid surface. It quantifies the wettability of the solid surface by the liquid. The contact angle is a reflection of how strongly the liquid and solid molecules interact with each other, relative to how strongly each interacts with its own kind.

The method further includes a third step 130 of providing a virtual simulation software. Many programs or code including GOMA Sandia National Lab code, Flow3D®, and/or FEFLOW may be used. FLOW-3D® is a commercially available multi-physics software code developed and distributed by Flow Science, Inc., Santa Fe, N. Mex. FLOW-3D® can be run on a desktop computer or a computer having a more advanced operating system such as UNIX.

The method further includes a fourth step 140 of providing parameters into the model for the virtual body model and/or the virtual absorbent article model. Parameters may include, for example, virtual body properties including advancing and receding contact angles. Parameters may also include, for example, virtual absorbent article properties such as, for example, advancing and receding contact angles, permeability, porosity, capillary pressure and surfactant concentration. Parameters may also include fluid properties, such as, for example, density, viscosity, mass or volume, and surface tension.

A parameter can be a variable of a function of saturation of the virtual absorbent article, such as, for example, saturated permeability, relative permeability, capillary pressure, irreducible fluid saturation, maximum fluid capacity, capillary pressure versus saturation relationship, and relative permeability versus saturation relationship.

A parameter can describe the spatial relationship between the virtual absorbent article and the virtual body model. A parameter can describe the movement relationship between the virtual absorbent article and the virtual body model.

The output of the model can be controlled based on the parameters used for the fluid properties. By inserting set parameters versus others, the model may be asked to derive the alternative properties.

The method 100 further includes a fifth step 150 of running a virtual simulation of the fluid balance of the virtual absorbent article model in a proximity with the virtual body model. A Computational Fluid Dynamics (CFD) code can be used to accurately simulate the impact of free surface and porous media fluid flow at interface between virtual absorbent article model and virtual body surfaces.

A virtual simulation of the fluid balance of the virtual absorbent article model in proximity with the virtual body model can be run using CFD software. One CFD program suitable for practicing the methods disclosed herein is GOMA, Sandia National Lab code. The virtual simulation of the fluid balance of the virtual absorbent article model can be performed in a one-dimensional, two-dimensional, or three-dimensional framework.

The model can be used to determine the impact of wettability conditions at the porous surface and the solid surface, porous material capillarity and permeability, fluid properties including non-Newtonian effects, and the amount of fluid absorbed into the porous material as a function of time.

In various embodiments, one or more computer based CAE models can include one or more defined interactions that differ from real world physical interactions, in order to account for inherent limitations in the models and/or to more accurately represent the overall physical behaviors of the real world things, as will be understood by one of ordinary skill in the art. These interactions can be defined in the Fluid-Solid Interaction (FSI) software.

The method includes a sixth step 160 of determining the absorbent article effectiveness of the virtual absorbent article model in proximity with the virtual body model. Determining the absorbent article effectiveness includes determining the lotion effectiveness of the virtual absorbent article model in proximity with the virtual body model. Determining the lotion effectiveness of the virtual absorbent article can include transforming the virtual absorbent article while accounting for any lotion properties. Transforming the virtual absorbent article can include, for example, transforming the absorbent article due to swelling while accounting for lotion properties. Determining the lotion effectiveness of the virtual absorbent article can include, for example, determining the Fluid on Surface (FOS) for a given virtual absorbent article contact angle and a given virtual body contact angle at a given time in the model. This can be plotted for various contact angles of the materials and the body to determine the amount of fluid left behind on the surface for a given set of parameters.

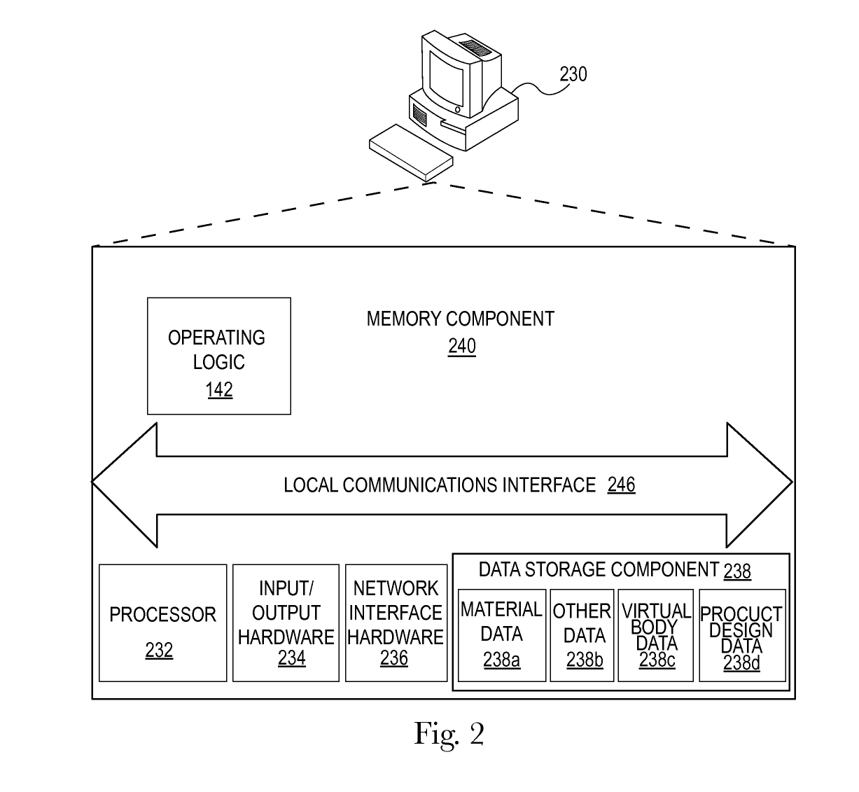

FIG. 2 depicts a computing device 230 according to systems and methods disclosed herein. The computing device 230 includes a processor 232, input/output hardware 234, network interface hardware 236, a data storage component 238 (which stores image data 238a, other data 238b, virtual body data 238c, and product design data 238d), and a memory component 240. The computing devices 230 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

The memory component 240 can be configured to store operating logic 142 that can be embodied as a computer program, firmware, and/or hardware, as an example. The operating logic 142 may include an operating system, web hosting logic, and/or other software for managing components of the computing device 230. A local communications interface 246 is also included in FIG. 2 and can be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

Similarly, it should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. Or, the data storage component 238 may merely be a peripheral device external to the computing device 230.

It should be understood that the computing device 230 components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. It should also be understood that, while the computing device 230 in FIG. 2 is illustrated as a single system, this is also merely an example. In some systems and methods, the modeling functionality is implemented separately from the prediction functionality, which may be implemented with separate hardware, software, and/or firmware.

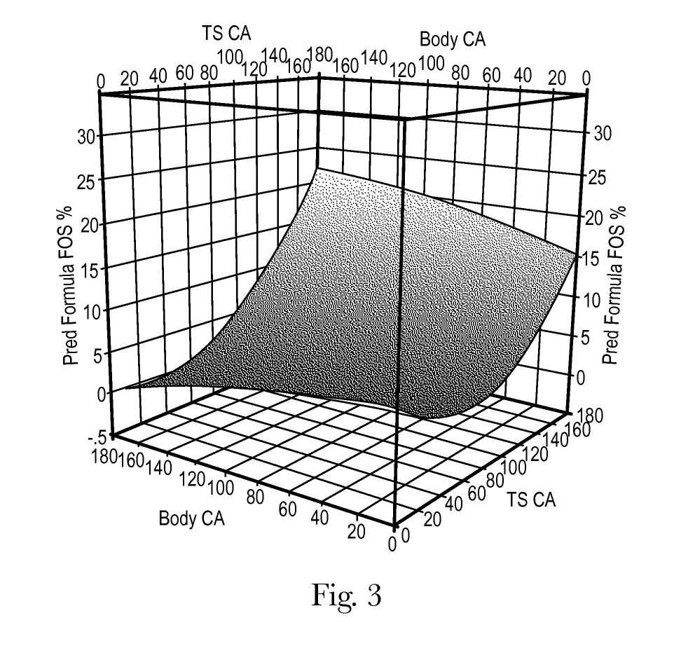

FIG. 3 is a graphical representation of an output generated according to the model. The graphical representation shows the percentage of the initial fluid not absorbed by absorbent article as Fluid on Surface (FOS) plotted against the lotion treated or non-treated body contact angle and the treated or non-treated topsheet contact angle of the absorbent article. This graphical representation represents multiple data points graphed together. The data can then be utilized in determining the appropriate combination of topsheet contact angle versus the lotion properties to have the desired product clean body benefit.

FIG. 4 is a schematic representation of a meshed virtual absorbent article model 400 comprising more than one type of material. The meshed model includes a topsheet 410, a backsheet 420, and an absorbent core 430 disposed between the topsheet 410 and the backsheet 420.

The computer based model can be created as described below, with general references to a computer based model of an absorbent article. A computer based model that represents an absorbent article can be created by providing dimensions and material properties to modeling software and by generating a mesh for the article using meshing software.

A computer based model of an absorbent article can be created with dimensions that are similar to or the same as dimensions that represent parts of a real world absorbent article. These dimensions can be determined by measuring actual samples, by using known values, or by estimating values. Alternatively, a model of an absorbent article can be configured with dimensions that do not represent a real world absorbent article. For example, a model of an absorbent article can represent a new variation of a real world absorbent article or can represent an entirely new absorbent article. In these examples, dimensions for the model can be determined by varying actual or known values, by estimating values, or by generating new values. The model can be created by putting values for the dimensions of parts of the absorbent article into the modeling software.

The computer based model of the absorbent article can be created with material properties that are similar to or the same as material properties that represent a real world absorbent article. These material properties can be determined by measuring actual samples, by using known values, or by estimating values. Alternatively, a model of an absorbent article can be configured with material properties that do not represent a real world absorbent article. For example, a model of an absorbent article can represent a new variation of a real world absorbent article or can represent an entirely new absorbent article. In these examples, material properties for the model can be determined by varying actual or known values, by estimating values, or by generating new values. The computer based model of the absorbent article can be created with more than one type of a virtual absorbent material.

The computer based model of the absorbent article can be created with a mesh for the parts of the article. A mesh is a collection of small, connected polygon shapes that define the set of discrete elements in a CAE computer based model. The type of mesh and/or the size of elements can be controlled with user inputs into the meshing software, as will be understood by one of ordinary skill in the art. In an exemplary embodiment, an external surface of an absorbent article can be created by using shell elements, such as linear triangular elements (also known as S3R elements) with an element size of about 1.5 millimeters, to represent a nonwoven material. Also, in an exemplary embodiment, an absorbent material can be created by using solid elements, such as linear hexahedral elements (also known as C3D8R elements) with an element size of about 1.5 millimeters.

FIG. 5 is a schematic of a computer based model that represents a portion of a female human body 500. The female human body includes a vaginal opening 520, a support structure 530 and a flesh structure 540. The vaginal opening 520 is located in an anatomically correct location, which is at the rear of the pudendal region. The vaginal opening 520 has a small amount of vaginal fluid 510 exiting the vaginal canal. The support structure 530 provides an approximation of a skeletal system of a human body. In various embodiments, the support structure 530 can be configured to allow the female human body 500 to move in a manner that is similar to or the same as real-world movements of the human body.

In embodiments wherein the support structure 530 allows the female human body 500 to move, the flesh structure 540 can be configured to follow the support structure in such movements. In various embodiments, the flesh structure 540 can be configured to deform in a manner that is similar to or the same as real-world deformation of the human body.

In various embodiments, wherein the female human body 500 can move, the computer based model of the female human body 500 can be constrained to assume one or more particular positions, or to assume one or more changes in position. The particular positions can include lying down, sitting, on hands and knees, kneeling, standing, or any other position that can represent a real world body position, or variations of any of these. The changing of positions can include twisting, turning, leaning, rocking, rolling, crawling, cruising, walking, jumping, running, or any other change of positions that can represent a real world body movement, or variations of any of these. The changing of positions can be accomplished by moving the model through the positions in series, by moving the model in a discontinuous fashion, or by moving the model in a continuous fashion. In various embodiments, the model of the female human body 500 can be configured to assume changes in position that are similar to or the same as a human body's natural range of motion.

The computer based model 500 can be created as described below, with general references to a computer based model of a human body. A computer based model that represents a human body can be created by providing dimensions and material properties to modeling software and by generating a mesh for the article using meshing software.

A computer based model of a human body can be created with dimensions that are similar to or the same as dimensions of one or more real world human bodies. These dimensions can be determined by measuring bodies, by using known values, or by estimating values. The model can be created by putting values for dimensions of the human body into the modeling software.

The computer based model of the human body can be created with material properties that are similar to or the same as material properties that represent a real world human body. These material properties can be determined by measuring actual samples, by using known values, or by estimating values.

The computer based model of the human body can be created with a mesh for the parts of the body. In an exemplary embodiment, a support structure of a human body can be created by using shell elements, such as S3R, defined as rigid element sets, with an element size of about 6.5 millimeters. Also, in an exemplary embodiment, a flesh structure of a human body can be created by using deformable, solid elements, such as C3D4 with an element size of about 4 millimeters.

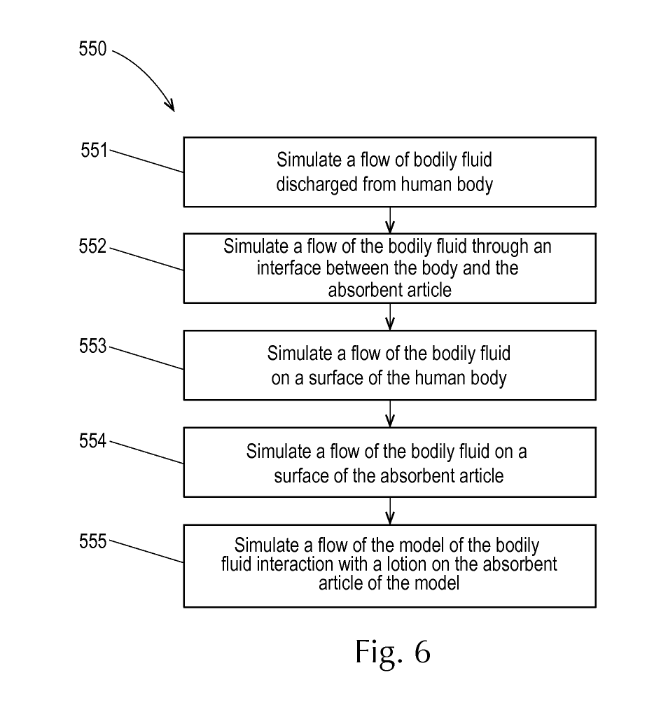

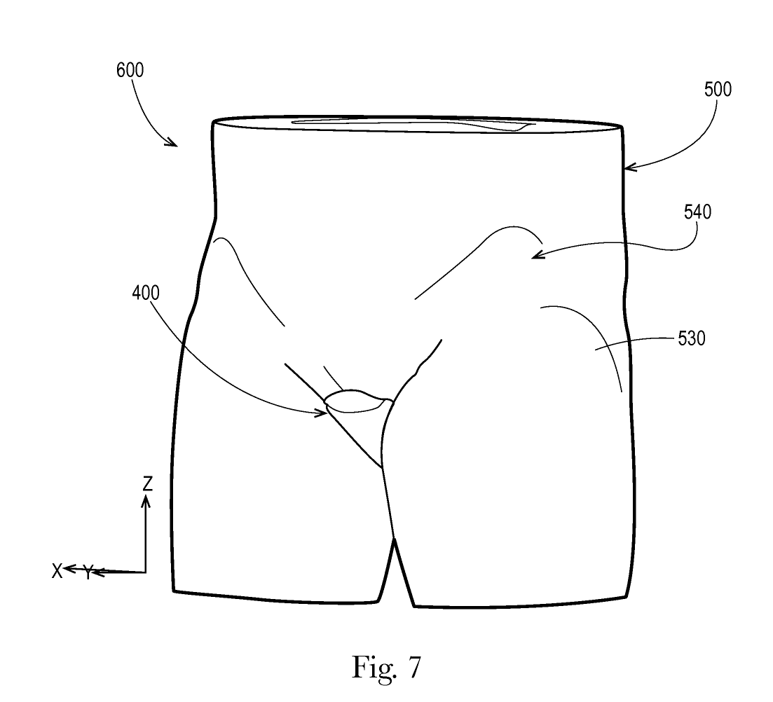

FIG. 6 is a chart illustrating a method 550 of using computer based models for simulating the discharge and flow of a bodily fluid in an absorbent article. Part, or parts, or all of the method 550 can be used in the fifth step 150 of the method 100 of the embodiment of FIG. 1. Accordingly, in the description of the method 550, a reference to an absorbent article refers to a computer based model of an absorbent article, as described in connection with the second step 120 of the method 100 of the embodiment of FIG. 1, and a reference to a human body refers to a computer based model of a human body, as described in connection with the first step 110 of the method 100 of the embodiment of FIG. 1. The steps of the method 550 are also explained in relation to the embodiments of FIG. 7, as described below. Although the steps 551-555 are described in numerical order in the present disclosure, in various embodiments some or all of these steps can be performed in other orders, and/or at overlapping times, and/or at the same time, as will be understood by one of ordinary skill in the art.

The method 550 includes a first step 551 of simulating a flow of bodily fluid as it is discharged from the human body. The discharge in the first step 551 can simulate a discharge of a discharge of menses from a female human body or a discharge of any kind of bodily fluid from a female human body, or an androgynous human body.

A computer based model that represents a bodily fluid can be created by providing volume and material properties to modeling software and by generating a mesh for the fluid using meshing software. A computer based model of a bodily fluid can be created with a volume that is similar to or the same as a volume of one or more discharges from real world human bodies. These volumes can be determined by measuring discharges of bodily fluids, by using known values, or by estimating values. The model can be created by putting values for a volume of the bodily fluid into the modeling software. The computer based model of the human body can be created with fluid properties that are similar to or the same as fluid properties that represent a real world bodily fluid. These material properties can be determined by measuring actual samples, by using known values, or by estimating values.

A model of a bodily fluid can be created by using structured mesh cells, such as finite volumes with a cell size of about 1 millimeter, to represent menses. Menses can also be modeled in various ways, as a Newtonian or non-Newtonian fluid.

The method 550 includes a second step 552 of simulating a flow of the model of bodily fluid through an interface between a human body and an absorbent article. A computer based model that represents lotion treated product in proximity with the body can be created by providing dimensions and lotion properties to modeling software and by generating a mesh for the lotion treated product using meshing software. In an alternate embodiment of the method 550, the second step 552 can be omitted, and the model of the bodily fluid can be provided to the model of the absorbent article without simulating a movement through an interface.

The method 550 includes a third step 553 of simulating a flow of the model of bodily fluid on a surface of the model of the human body. In an alternate embodiment of the method 550, the third step 553 can be omitted, and the model of the bodily fluid can be provided to the model of the absorbent article without simulating a flow of the model of bodily fluid on a surface of the model of the human body.

The method 550 also includes a fourth step 554 of simulating a flow of the model of bodily fluid on a surface of the model of the absorbent article.

The method 550 can include a fifth step 555 of simulating a flow of the model of the bodily fluid interaction with a lotion on the absorbent article of the model.

FIG. 7 is a front view illustrating a computer based model 600 of the virtual absorbent article model of FIG. 4 fitted on the virtual body model of FIG. 5. The absorbent article 400 is placed in located over the vaginal opening. The computer based model represents a portion of a female human body 500. The female human body includes a support structure 530 and a flesh structure 540. The support structure 530 provides an approximation of a skeletal system of a human body. In various embodiments, the support structure 530 can be configured to allow the female human body 500 to move in a manner that is similar to or the same as real-world movements of the human body.

Vaginal fluid originates from the female vaginal opening and flows on an external surface of the female human body 500 and/or through air to the wearer-facing external surface of the feminine pad absorbent article 400. The vaginal fluid then flows on and/or through the wearer-facing external surface, as well as into and/or through the absorbent material. CFD program instructions can execute to simulate each of these fluid flows.

The flesh structure 540 provides an approximation of the skin, tissue, muscle, and organs of a male human body. In the embodiment of FIG. 7, the flesh structure 540 is intended to represent the portion of the female human body 500 that is not represented by the support structure 530. However, in alternate embodiments, the skin, tissue, muscle, and/or organs of a human body can be represented by a number of separate structures.

The computer based models can be created as described below, with general references to computer based models of absorbent articles, garments, and human bodies. In a computer based model, the fitting of an absorbent article to a human body may represent an ideal fit as intended by the manufacturer of the absorbent article, or the fitting may represent a less than ideal fit as sometimes occurs in the real-world use of absorbent articles. Additionally, a computer based model can represent the removal of an absorbent article from a human body, in various ways. These approaches can be accomplished with the use of boundary conditions in the models, as will be understood by one of skill in the art.

A computer based model that represents a human body and an absorbent article can also include a representation of part, or parts, or all of one or more environmental objects and/or one or more environmental conditions. An environmental object can be any object that would physically interact with an absorbent article or a human body in the real-world. For example, an environmental object can be a changing surface, on which a human body is placed when fitting an absorbent article to the body. An environmental condition can be any condition that would physically interact with an absorbent article or a human body in the real-world. As examples, an environmental condition can be gravity, hot or cold temperatures, etc.

A computer based model that represents a human body and an absorbent article can include defined interactions between its parts. Defined interactions are prescribed terms that govern physical relationships within a computer based model. Examples of defined interactions include terms that govern the presence, absence, or magnitude of contact, friction, relative movement, and other physical relationships. Each defined interaction can be assigned a particular value and extent within the model. These interactions can be determined by observing, measuring, analyzing, and/or estimating real world physical interactions. In various embodiments, computer based models can also include one or more defined interactions that differ from real world physical interactions, in order to account for inherent limitations in the models and/or to more accurately represent the overall physical behaviors of real world things, as will be understood by one of ordinary skill in the art. Defined interactions can act on the model in various ways, to allow, prohibit, amplify, or limit one or more physical relationships in the model. The model includes defined interactions that allow part, or parts, or all of the human body to physically interact with part, or parts, or all of the absorbent article. When a model includes a garment, the model can include defined interactions that allow part, or parts, or all of the garment to physically interact with part, or parts, or all of the absorbent article, and/or to physically interact with part, or parts, or all of the human body. When a model includes environmental objects or conditions, the model can include defined interactions that allow part, or parts, or all of the environmental objects or conditions to physically interact with part, or parts, or all of the absorbent article, and/or to physically interact with part, or parts, or all of the human body.

For fluid flow in an absorbent material, the continuity equation can be written as follows:

$$\vec{▽} \cdot \vec{J} + φ \frac{\partial S}{\partial t} = 0$$

where J is the fluid flux, φ is the porosity of the absorbent, S is the fluid saturation, and t is time. In capillary-flow theory, the fluid flux is considered to be governed by Darcy's law:

$$\vec{J} = - \frac{{kk}_{r}}{μ} ( \vec{▽} {P}_{cap} - ρ \vec{g} )$$

where k is the intrinsic permeability (e.g., saturated permeability), kᵣ is the relative permeability, μ is the fluid viscosity, P_{cap} is the capillary pressure, ρ is the fluid density, and g is the gravitational constant.

To solve the fluid flux equation in partially saturated porous media, constitutive equations describing the relative permeability and capillary pressure as functions of saturation are needed. These constitutive relationships are among the absorbent-fluid interaction properties for the absorbent.

The capillary pressure versus saturation function for the absorbent can be characterized using a modified van Genuchten function having the following form (van Genuchten, M. T. (1980), “A Closed-Form Equation for Predicting the Hydraulic Conductivity of Unsaturated Soils,” Soil Science Society of America, 44, 892-898):

$${P}_{cap} = - {{P}_{0} ( {S}^{* ( - \frac{1}{m} )} - 1 )}^{( \frac{1}{n} )}$$

where Pₒ, m, and n are parameters defining the shape of the capillary pressure versus saturation function. S* is defined by the relationship:

$${S}^{*} = \frac{{S}_{l} - {S}_{lr}}{{S}_{ls} - {S}_{lr}}$$

where Sₗ is the actual fluid saturation, Sₗᵣ is the irreducible fluid saturation, and Sₗₛ is the maximum fluid saturation. The absorbent-fluid interaction properties for the absorbent include Pₒ, m, n, Sₗₛ, and Sₗᵣ. The parameters, Pₒ, m, n, Sₗₛ, and Sₗᵣ can be determined by curve-fitting the modified van Genuchten function for capillary pressure versus saturation to the experimental data obtained in the physical test environment reported in the physical spatial map of saturation. The capillary pressure versus saturation function is commonly referred to as the capillary pressure function.

Curve-fitting can be performed using any means known to those skilled in the art including, but not limited to, RETC (van Genuchten, M. T., Leji, F. J., and Yates, S. R., (1991), “The RETC Code for Quantifying the Hydraulic Functions of Unsaturated Soils, Version 1.0,” EPA Report 600/2-91/065, U.S. Salinity Laboratory, U.S.D.A., A.R.S., Riverside, Calif.), customized least squares regression method (e.g., FORTRAN subroutine), commercial non-linear regression software (e.g., JMP available from SAS Institute Inc., Cary, N.C. and MAPLE available from MAPLESOFT, Ontario, Canada), and customized commercial optimization algorithms (e.g., MAPLET).

The capillary pressure is constrained by the following limitation:

−Pₘₐₓ≦P_{cap}≦0

where Pₘₐₓ is the maximum capillary pressure that can be sustained in the absorbent.

Directly measuring the relative permeability as a function of saturation, commonly referred to as the relative permeability function, can be challenging. Inverse simulation can be used to establish the relative permeability function. The van Genuchten-Mualem model can be used to describe the relative permeability function (see van Genuchten, M. T. (1980), “A Closed-Form Equation for Predicting the Hydraulic Conductivity of Unsaturated Soils,” Soil Science Society of America, 44, 892-898 and Mualem, Y. (1976), “A New Model for Predicting the Hydraulic Conductivity of Unsaturated Porous Media,” Water Resources Research, 12(3), 513-522). The van Genuchten-Mualem model is:

$${k}_{r} = {\sqrt{{S}^{*}} [ 1 - {( 1 - {[ {S}^{*} ]}^{\frac{1}{λ}} )}^{λ} ]}^{2}$$

where λ is a fitting parameter that is partially descriptive of the shape of the relative permeability function. The parameter λ is also one of the absorbent-fluid interaction properties for the absorbent.

The relative permeability is defined as:

$${k}_{r} = \frac{{k}_{{s}^{*}}}{k}$$

where k_{s*} is the permeability at a particular S* and k is the intrinsic permeability (e.g., saturated permeability). Typically, the parameter X, is the unknown for which a value is sought because the parameters Pₒ, m, n, Sₗₛ, and Sₗᵣ can be determined by curve fitting the modified van Genuchten capillary pressure versus saturation function to the physical spatial map of saturation.

For free surface flow, the volume-of-fluid variable is used to conflate the material properties of the separate phases into a single equation. For example, the density and viscosity functions can be expressed as follows:

ρ(γ)=ρ₁γ+ρ₂(1−γ)

and

η(γ)=η₁γ+η₂(1−γ)

where ρ₁ and ρ₂ are the densities of phase 1 and phase 2 respectively. Similarly, η₁ and η₂ are the individual phase viscosities.

Since the two phases are immiscible, evolution of the volume-of-fluid variable occurs according to the purely hyperbolic advection operator:

$$\frac{\partial γ}{\partial t} + ▽ \cdot ( \vec{v} γ ) = 0$$

where \vec{v} is a global fluid velocity field.

Under the assumption that both phases are incompressible, this velocity field can be obtained from the Navier-Stokes equations:

$$ρ ( γ ) \frac{\partial \vec{v} }{\partial t} + ρ ( γ ) \vec{v} \cdot ▽ \vec{v} = - ▽ p + ▽ \cdot ( μ ( γ ) ▽ \vec{v} ) + ρ ( γ ) \vec{g} + {\vec{ϕ}}_{Γ}$$

and Continuity equations

∇·\vec{v}=0

where p is the isotropic pressure and \vec{g} is the gravitational acceleration vector. The term, φ_{γ}, is a body force associated with the surface tension forces at the interface surface F. It can be found from the following equation:

\vec{φ}_{Γ}(\vec{r}_{Γ})=σ(∇·\vec{n}_{Γ})\vec{n}_{Γ}δ(\vec{r}_{Γ})

where σ is the surface tension, \vec{n}_{Γ} is the normal vector field to the interface surface, and δ(\vec{r}_{Γ}) is a Dirac function centered on the interface surface. The volume-of-fluid field is used to find both the interface surface location and its normal vector field.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of simulation, comprising:
providing a virtual body model;
providing a virtual absorbent article model;
providing parameters to the virtual body model and the virtual absorbent article model;
running a virtual simulation of the fluid balance of the virtual absorbent article model in a proximity with the virtual body model; and
determining a lotion effectiveness of the virtual absorbent article model in proximity with the virtual body model.

2. The method according to claim 1, wherein the virtual simulation comprises a parameter selected from the group consisting of a parameter describing the advancing and receding contact angles of the virtual body model, and a parameter describing the advancing and receding contact angles of the virtual absorbent article model.

3. The method according to claim 1, wherein the virtual simulation comprises a parameter that is a variable of a function of saturation of the virtual absorbent article.

4. The method according to claim 3, wherein the parameter is a variable function of saturation of the virtual absorbent article selected from the group consisting of saturated permeability, relative permeability, capillary pressure, irreducible fluid saturation, maximum fluid capacity, capillary pressure versus saturation relationship, and relative permeability versus saturation relationship.

5. The method according to claim 1, wherein the virtual absorbent article model comprises more than one type of a virtual absorbent material.

6. The method according to claim 1, wherein the virtual absorbent article model comprises a virtual topsheet, a virtual backsheet, and a virtual absorbent core disposed between the virtual topsheet and the virtual backsheet.

7. The method according to claim 1, wherein the virtual simulation comprises a parameter describing the spatial relationship between the virtual absorbent article and the virtual body model.

8. The method according to claim 1, wherein the virtual simulation comprises a parameter describing the movement relationship between the virtual absorbent article and the virtual body model.

9. The method according to claim 1, wherein the virtual absorbent article model is an absorbent article selected from the group consisting of sanitary napkins, pantiliners, incontinent pads, interlabial pads, diapers, and breast pads.

10. The method according to claim 1, wherein determining a lotion effectiveness of the virtual absorbent article model in proximity with the virtual body model further comprises determining a percent fluid on surface for a virtual body contact angle and a virtual absorbent article contact angle.

11. A system for modeling fluid balance of a virtual absorbent article model with a lotion in proximity with a virtual body model, comprising:
a memory component that stores logic that when executed by a system causes the system to perform at least the following:
providing the virtual body model;
providing the virtual absorbent article model;
providing parameters to the virtual body model and the virtual absorbent article model;
running a virtual simulation of the virtual absorbent article model in a proximity with the virtual body model; and
determining the lotion effectiveness of the virtual absorbent article model in proximity with the virtual body model.

12. The system according to claim 11, wherein the virtual simulation comprises a parameter selected from the group consisting of a parameter describing the advancing and receding contact angles of the virtual body model, and a parameter describing the advancing and receding contact angles of the virtual absorbent article model.

13. The system according to claim 11, wherein the virtual simulation comprises a parameter that is variable as a function of saturation of the virtual absorbent article.

14. The system according to claim 13, wherein the parameter that is variable function of saturation of the virtual absorbent article is selected from the group consisting of saturated permeability, relative permeability, capillary pressure, irreducible fluid saturation, maximum fluid capacity, capillary pressure versus saturation relationship, and relative permeability versus saturation relationship.

15. The system according to claim 11, wherein the virtual absorbent article model comprises more than one type of virtual absorbent material.

16. The system according to claim 11, wherein the virtual simulation comprises a parameter describing the spatial relationship between the virtual absorbent article and the virtual body model.

17. The system according to claim 11, wherein the virtual simulation comprises a parameter describing the movement relationship between the virtual absorbent article and the virtual body model.

18. The system according to claim 11, wherein the virtual absorbent article model is an absorbent article selected from the group consisting of sanitary napkins, pantiliners, incontinent pads, interlabial pads, diapers, and breast pads.

19. The system according to claim 11, wherein determining a lotion effectiveness of the virtual absorbent article model in proximity with the virtual body model further comprises determining a percent fluid on surface for a virtual body contact angle and a virtual absorbent article contact angle.

20. A method of simulation, comprising:
providing a virtual body model;
providing a virtual absorbent article model;
providing parameters to the virtual body model and the virtual absorbent article model;
running a virtual simulation of the fluid balance of the virtual absorbent article model in a proximity with the virtual body model; and
determining a determining a percent fluid on surface for a virtual body contact angle and a virtual absorbent article contact angle.
